(19) United States
(12) Patent Application Publication
(10) Pub. No.: US 2026/0168909 A1
(43) Pub. Date: Jun. 18, 2026

(54) NOZZLE OPTICAL MANIFOLD

(71) Applicant: The Aerospace Corporation, El Segundo, CA (US)

(72) Inventor: James M. HELT, Playa del Rey, CA (US)

(73) Assignee: The Aerospace Corporation, El Segundo, CA (US)

(21) Appl. No.: 18/986,367

(22) Filed: Dec. 18, 2024

(51) Int. Cl. G01N 11/04; G01N 11/00

(52) U.S. Cl. CPC G01N 11/04; G01N 2011/006

(57) ABSTRACT

Nozzle Optical Manifold (NOM) includes a tube, which includes an optical beam transmitted down the center of the tube. Simultaneously, NOM measures, with a fiber optic film thickness measurement beam, at the center of the tube. Tube has a gas jet emitted from a nozzle that impinges on the surface of the substrate that has a thin film. The thickness of the thin film is reduced in thickness as the gas jet impinges thereon. It should be appreciated that, depending on the embodiment, any fluid that impinges on the surface of the thin film may be used.

### FIELD

The present invention relates to fiber optic probes, and more particularly, to a nozzle optical manifold (NOM) for fiber optic probes.

### BACKGROUND

National Security Space (NSS) utilizes specialty fluids in a range of applications where they serve to lubricate tribological contacts, as coatings precursors, as heat transfer media, as dampening and hydraulic fluids. For instance, when a spacecraft moving mechanical assembly (MMA) is placed in space, including a control moment gyroscope (CMG) or reaction wheel assembly (RWA), there is often a finite supply of lubricant.

Due to the finite lubricant supply, it is important to understand how the quantity and physical properties of the MMA's lubricant evolves over time during operation in space. This process of evolution includes understanding changes in the lubricant's viscosity due to tribological degradation, which directly impacts how much lubricant life may be left for optimal performance.

It should also be noted that it is important to understand why a lubricant's local viscosity is critical to tribology. For example, the change in the lubricant's viscosity with use correlates to the lubricant's health, the remaining “life” of the lubricant, and the counter body tribological performance. In one example, a lubricant's viscosity is a key physical property found in elastohydrodynamic lubrication (EHL) theory that is used to model attitude control mechanism bearing performance. Changes to a lubricant's viscosity impact EHL film thickness and entrainment dynamic calculations.

Accordingly, there is a need to develop a technique to measure space-based liquid (e.g., lubricant) physical property evolution.

### SUMMARY

Certain embodiments of the present invention may provide solutions to the problems and needs in the art that have not yet been fully identified, appreciated, or solved by current liquid evolution measurement technologies. For example, some embodiments of the present invention pertain to a Nozzle Optical Manifold (NOM) device that allows an instrument capable of measuring the interfacial-rheological properties of thin fluid films and the surfaces that they coat. In certain embodiments, the NOM enables the construction of instruments such as Coaxial Thin Film Viscometer (CTFV) configured to take snapshots of a mechanism's fluid lubricant and surface that was in tribological contact. This snapshot provides an understanding of the evolution of the lubricant, i.e., quantify the evolution process (e.g. viscosity vs. time or operating cycles). It should be noted that in certain embodiments the CTFV performs measurement of the fluid and surface after the mechanism is used and taken apart.

In one embodiment, NOM may include a manifold body comprising of bores and holes configured to simultaneously transmit an optical beam and a normal impinging gas jet onto a surface of a substrate, wherein the surface of the substrate comprises a thin fluid film. The manifold body may include a hole/bore that accepts the fiber optic probe of a film thickness measurement instrument. Once the fiber optic probe is placed inside of the hole/bore, a measurement beam from the fiber optic probe is optically aligned with an impingement point. The impingement point is a location at which the optical beam measuring the thickness of the thin fluid film and the gas jet exiting the nozzle impinging onto the thin fluid film. Together, the NOM and fiber optic film thickness instrument are configured to measure viscosity of the thin fluid film by analyzing time series film thinning data. In short, the viscosity of the thin fluid film is measured by acquiring film thickness versus time data during a gas jet impingement process.

In another embodiment, a NOM may include a tube configured to transmit an optical beam and gas jet onto a surface of a substrate. The surface of the substrate comprises a thin fluid film. The NOM may also include a tube configured to transmit an optical beam and gas jet onto the surface of a substrate, wherein the surface of the substrate comprises a thin fluid film, and a fiber optic probe placed inside of the tube and the optical beam from the fiber optic probe is optically aligned with the jet impingement point. The impingement point is a location at which the optical beam impinges onto the thin fluid film. The NOM further includes a nozzle attached to the tube and is configured to impinge a gas jet onto thin film fluid, allowing for viscosity of the thin film fluid to be measured. The fiber optic probe is configured to measure viscosity of the thin film fluid by acquiring film thickness versus time data.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting its scope, the invention will be described and explained with additional specificity and detail through the use of the accompanying drawings, in which:

FIG. 1 is a diagram illustrating a NOM for fiber optic film thickness probes, according to an embodiment of the present invention.

FIGS. 2A-F are diagrams illustrating various views of a linear NOM, according to an embodiment of the present invention.

FIG. 3 is a graph illustrating CTFV curves using a linear NOM for a homologous series of fluids, according to an embodiment of the present invention.

FIG. 4A-C are images acquired with camera illustrating the stagnation point between the jet and the thin film fluid, according to an embodiment of the present invention.

FIGS. 5A-E are diagrams illustrating an angled NOM, according to an embodiment of the present invention.

FIGS. 6A and 6B are diagrams illustrating a configuration for triangulating with a position sensitive detector (PSD), according to an embodiment of the present invention.

FIG. 7 is a diagram illustrating a camera triangulation schematic, according to an embodiment of the present invention.

FIGS. 8A and 8B show images illustrating the use of camera triangulation, according to an embodiment of the present invention.

### DETAILED DESCRIPTION OF THE EMBODIMENTS

Some embodiments of the present invention pertain to a NOM device that allows construction of an instrument capable of measuring the interfacial-rheological properties of thin fluid films and the surfaces that they coat. In certain embodiments, the NOM enables the construction of instruments, such as a CTFV, configured to take local snapshots of a mechanism's fluid lubricant and surface that was in tribological contact. For purposes of explanation, the term local is used because measurements are made at a specific point on a test article of interest to the user. The size of the analysis spot is determined by the optics that focus a fiber optic measurement beam. As noted above, the CTFV performs measurements of the thin fluid film and surface but after the mechanism is used and taken apart. In certain embodiments, measurements on a mechanism may also be performed during construction of the mechanism to identify an initial starting condition that should be in-line with design specifications. This initial starting condition are then used to compare with the measurements after construction and/or use. This snapshot provides an understanding of the local evolution of the lubricant in tribologically critical regions, i.e., quantify the evolution process (viscosity vs. time). This allows for improvement of engineering designs, performance expectations and mission tasking.

With no commercial instruments available to perform the needed measurements, CTFV can measure the viscosity of thin fluid films resting relatively on space mechanism hardware and Research & Development (R&D) test materials. It should be appreciated that articles of interest may vary both in size and geometry, ranging from planar to concave and convex geometries (e.g., test coupons, cylindrical shafts, and bearing raceways, to name a few). It should also be appreciated that, unlike MEMS viscometers that require the liquid to be removed and placed into a MEMS device, the CTFV performs measurements without having to remove the thin fluid film from the article's surface.

In some embodiments, NOM includes one or more features/components that enable seamless mating/integration with fiber optic film thickness probes, ensure coaxial alignment of the film thickness measurement location with an impinging jet's stagnation point, and enable simultaneous monitoring and control of the impinging jet. The NOM features/components are used in construction of the CTFV instrument as the features/components enable routing (e.g., of cables, tubing, etc.), local property analysis of fluids on opaque materials relevant to space mechanisms, simplify the measurement process, expand the measurement protocols, improve accuracy and precision, and ease theoretical analysis.

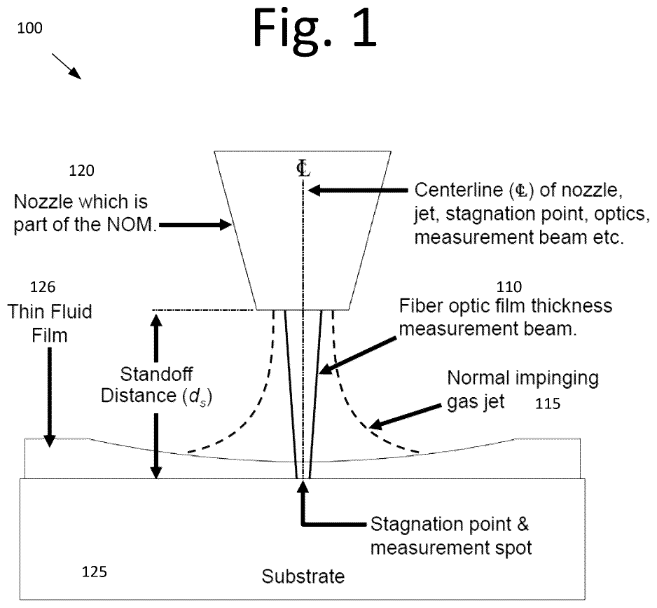

FIG. 1 is a diagram illustrating a NOM 100 for fiber optic film thickness probes, according to an embodiment of the present invention. In some embodiments, NOM 100 includes a hole/bore inside of or within the manifold that comprises a fiber optic film thickness measurement beam (the “optical beam”) 110 that is transmitted down the center of hole/bore and is configured to be emitted out of the center of nozzle 120. NOM 100 may measure, with optical beam 110, at the center of hole/bore. In some embodiments, also emitted out of nozzle 120 is a gas jet 115 that impinges orthogonal on surface of thin film fluid 126. Below thin film fluid 126, is a substrate 125. For purposes of explanation, the terms “gas jet”, “impinging gas jet” and “fluid jet” may be used interchangeably. Thin fluid film 126 may be reduced in thickness as gas jet 115 impinges thereon. It should be appreciated that, depending on the embodiment, any fluid which impinges on the surface thin fluid film 126, may be used (e.g. gas, liquid). Although not illustrated in this embodiment, mounted on or within the manifold is a lens, nozzle 120, and sensors, to name a few.

In fluid dynamics, the location at which the fluid (or gas) jet 115 impinges on the surface (or coating) of thin fluid film 126 is called the stagnation point and is a unique area of impinging gas jet 115. The theoretical background of stagnation point flow is described in literature and allows for the viscosity of the fluid to be measured from film thickness-time series data.

It should be appreciated that CTFV type instruments use stagnation flow models to measure a fluid's viscosity (n) and/or the jet's hydrodynamic constant (a). For Stokes flow, both parameters are contained in G which is termed the strength of the stagnation flow, as shown in Equation (1) below.

$$h ( t ) = \frac{{h}_{0}}{1 + {h}_{0} Gt} \qquad Equation ( 1 )$$

To construct and use CTFV for viscosity measurements, a calibration curve of the jet's hydrodynamic constant (a) is determined using fluids of known viscosities. Next, measuring and fitting h (t) thinning profiles is performed as a function of relevant parameters including the type of gas used (e.g. nitrogen), gas properties, gas flow rate (Q), nozzle geometry and standoff distance (dₛ). Standoff distance (dₛ) is the distance between the substrate surface (i.e., not the surface of the thin fluid film) and the tip of the nozzle. Once calibrated, h (t) thinning profiles of thin fluid films is measured, and the fluids viscosity is calculated by data fitting.

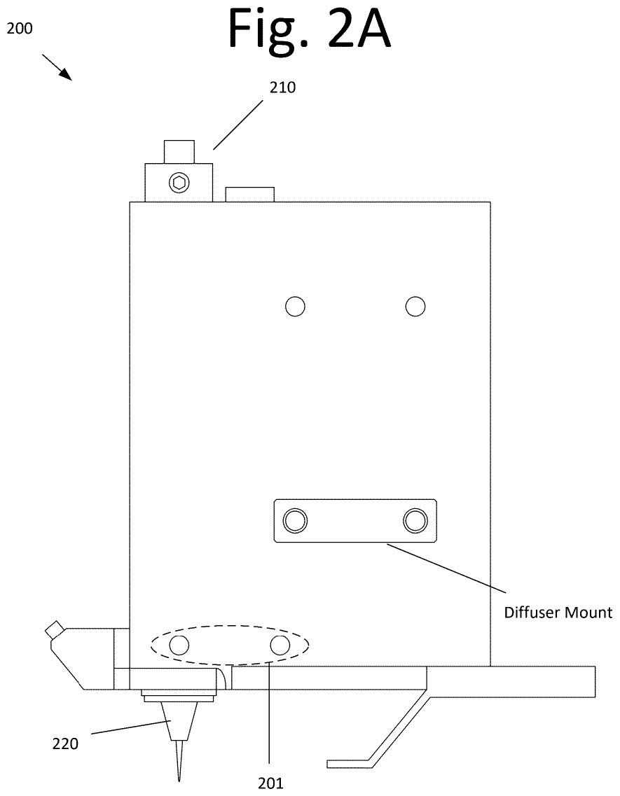

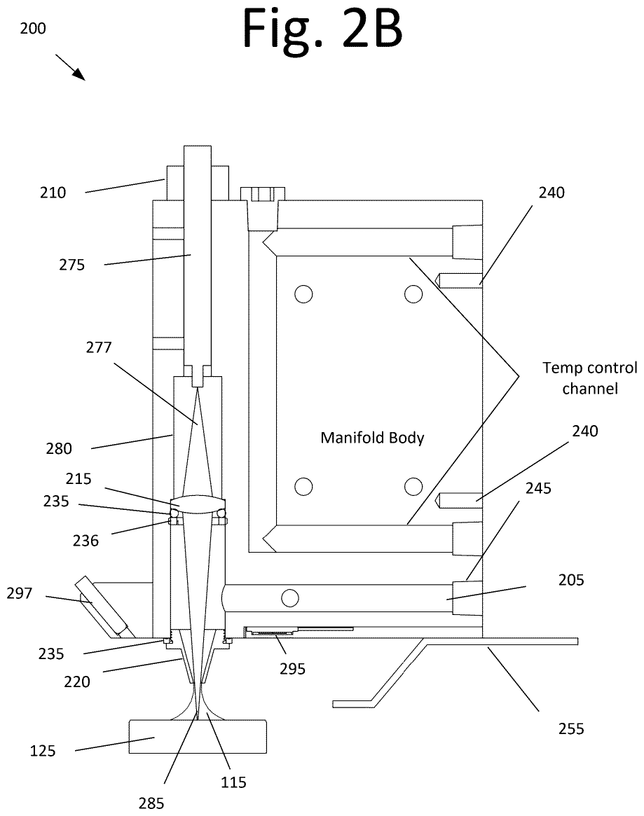

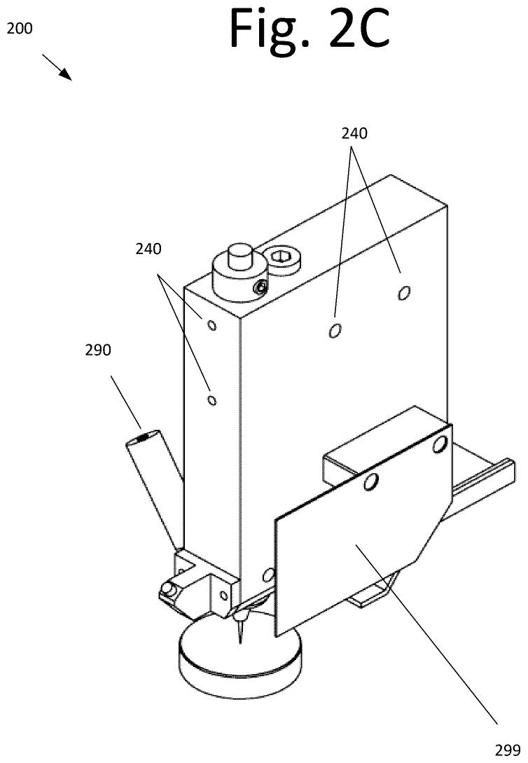

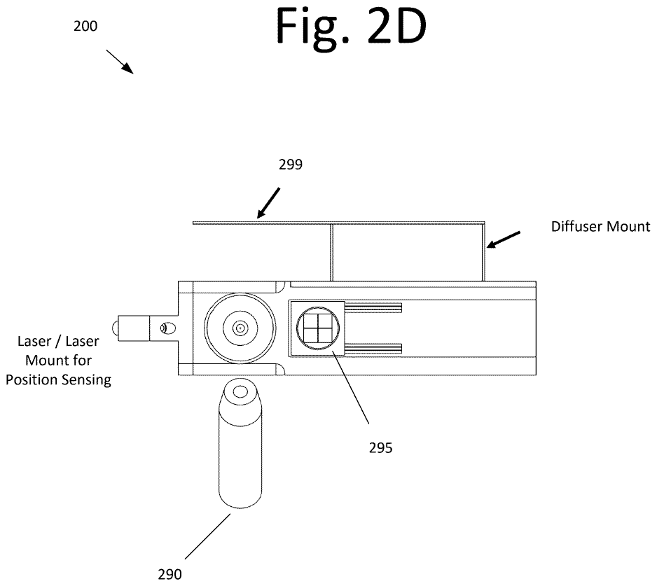

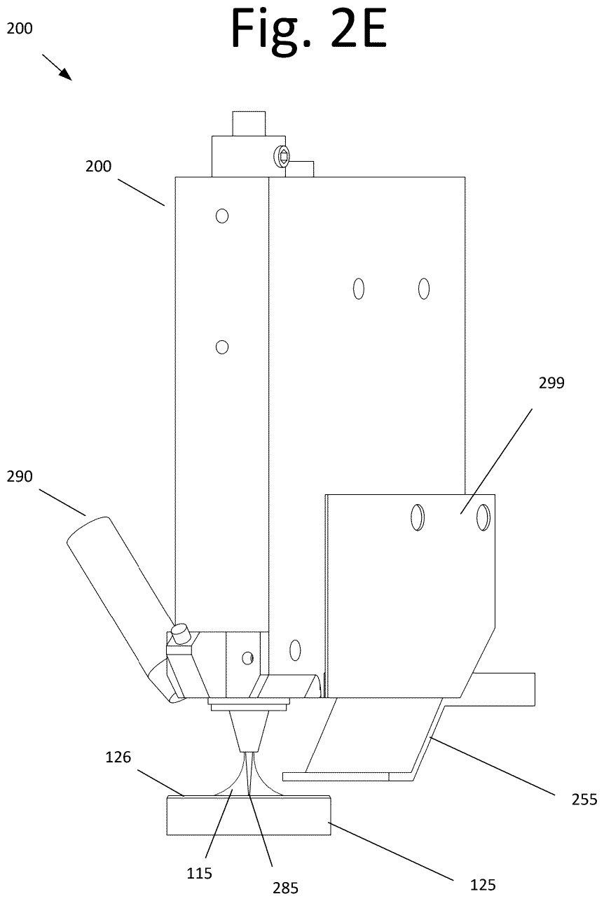

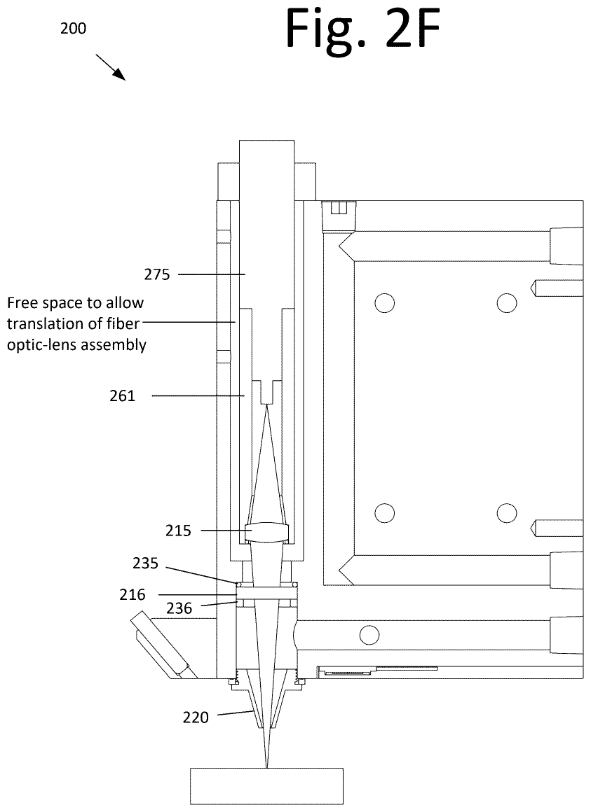

FIGS. 2A-E are diagrams illustrating various views of a linear NOM 200, according to an embodiment of the present invention. In some embodiments, linear NOM 200 uses a direct optical path when analyzing fluids coating articles with a direct line of sight, e.g., planar test coupons, silicon wafers, mirrors, lenses, shafts, and other non-confined geometries. Linear NOM 200 may include a jet supply line 205 for allowing gas or (liquid) jet to flow through the manifold body to nozzle 220 that is aligned with fiber optic probe 275 and mount 210 for reflectance measurement probe. In some embodiments, fiber optic mount 210 may be fixed or allow x-y-z translation.

For purposes of explanation/clarification, there may be several alignment combinations between the nozzle/lens/fiber optic probe, all which have the same description for this example. During practice, a person of ordinary skill in the art may fix one, say the lens, and have XYZ translation for the nozzle and fiber optic probe. This is however a matter of design choice. With high precision components, such as machining and assembly, a person of ordinary skill in the art may construct the NOM without positioners and the three are fixed.

It should be noted that, in some embodiments, a z-axis stage to mount and hold NOM 200 above substrate 125 may be included. For example, NOM 200 can be mounted to the z-axis stage using fixture hardware 240. This z-axis stage is what NOM 200 is mounted on when making a CTFV, allowing NOM 200 to be moved up or down relative to the substrate surface. It should be appreciated that when constructing a CFTV, mounting NOM 200 to a z-axis stage accommodates different substrate thicknesses, which preserves standoff distance dₛ, measurement spot focus and CTFV calibration. This z-axis stage, in some embodiments, provides motion relative to the substrate surface, whereas the XYZ translation positioners in the above paragraph are relative to each other and are primarily for alignment purposes (i.e., aligning the nozzle/lens/fiber optic probe).

In short, it should be noted that XYZ positioners are primarily used for alignment when making the CTFV. When, for example, the nozzle and fiber probe are aligned, adjustment to the positioner is no longer required. If the nozzle or fiber probe are switched, for example, then the XYZ positioners are used again to bring everything into alignment. With respect to the z-axis stage, this is used because samples have different thicknesses. Thus, the z-axis stage is used to move NOM 200 up and down to realize the correct standoff height (i.e., alignment is checked using PSD 295 or camera 290 triangulation).

Linear NOM 200 may also include a focusing lens 215 for a fiber optic beam 277, nozzle 220 mounted so that its orifice is aligned coaxially with the focused beam 285. In some embodiments, focusing lens 215 may be fixed or allow for a x-y-z translation. Linear NOM 200 may further include a plurality of sensors 201 configured to measure properties of gas (or liquid) jet (including other NOM components). In some embodiments, other NOM components include, but are not limited to, the nozzle, manifold body and environment.

In certain embodiments, linear NOM 200 includes one or more (O-ring) gaskets 235, which are below lens 215, to ensure flow is only through nozzle 220. It should be appreciated that there are a plurality of gaskets to ensure the fluid jet only flows through nozzle 220, thereby creating a jet. Below O-ring gaskets 235 are fasteners 236 which fix lens 215 in place against the manifold body. In some embodiments, the lens may be fixed to the manifold body with glue and therefore not require the gaskets 235 and or fastener 236. In other embodiments, the position of the lens may be adjustable, wherein the NOM may include a fixed transparent window (or lens/lenses) 216 mounted to the manifold body below the lens 215. For this configuration the gaskets 235 and fasteners 236 would be placed in contact with the transparent window 216 to ensure flow is only through nozzle 220. There is also an adaptor 261 for mounting lens 215 to fiber optic probe 275, which creates the fiber optic-lens assembly. See, for example, FIG. 2F showing transparent window 216 configuration and adaptor 261. Transparent window configuration includes, in this embodiment, O-ring 235, window 216, fastener 236, and fiber optic-lens assembly described above. Simply put, an optically transparent window is sealed against the manifold body and is below the focusing lens 215 creating a sealed chamber such that the fluid jet flows through the nozzle. For this configuration there may also be free space to allow translation of the fiber optic-lens assembly relative to the nozzle 220.

In some further embodiments, linear NOM 200 includes fixture hardware 240, flowmeter and controller 245 that controls the flow of gas, camera 290, and a blanking plate 255 for spectrometer and nozzle. In an embodiment the blanking plate 255 is used to measure spectrometer dark noise absent beam 285. In an embodiment, the blanking plate 255 may block the gas jet when locating a position on the sample for analysis. Also, in some embodiments, linear NOM 200 includes temperature sensors and pressure sensors (not shown) may be located near ports 201, and a position sensitive detector (PSD) 295 for measuring nozzle-substrate distance termed the standoff distance (dₛ).

Linear NOM 200 in some embodiments is customized such that nozzle 220 and sensors 295 are configured to measure and control the jet's nozzle pressure. In this embodiment, NOM 200 includes pressure sensors to measure both barometric and nozzle differential pressure. It should be appreciated that fiber optic probes 275 are in reflectance mode, i.e., transparency is not considered whereas substrate roughness is considered. For example, if the thin liquid film under analysis is below a certain thickness, then the substrate roughness impacts the measurement, thereby reducing the signal quality.

As shown in FIG. 2B, the fiber optic probe, which is preferably removable, may slide, screw or mount into a tube (or bore) 280 of the manifold body. Bore 280 is centered on to a lens 215 coaxially aligning the fiber optic probe beam 277. In this embodiment, fiber optic probe beam 277 is transmitted through lens 215 and directed through nozzle 220, and onto substrate 125. In other embodiments, and although not shown, fiber optic probe beam 277 may pass through one or more lenses 215. Lens 215 may be configured to focus fiber optic probe beam 277 onto substrate 215. During reflectance mode measurement, fiber optic probe beam 277 is reflected back from the surface of substrate 125 and through lens 215.

The (optical) alignment between the fiber optic probe 275 and lens 215 is also coaxially aligned with the nozzle 220 axis. The jet, which is emitted from a jet supply channel (connected to jet supply inlet 205), comes out of nozzle 220 resulting in a stagnation point at the center of nozzle 220. It should be appreciated that although the drawings may show a circular nozzle orifice that is radially symmetric, the nozzle 220 doesn't necessarily have to be radially symmetric, i.e., it can have a rectangle or triangle geometry or asymmetric, which can be of interest to fluid dynamics community. Equally, NOM 200 may include multiple fiber optic probes and spectrometers allowing measurements to be conducted at different jet impingement locations. For example, in embodiments that use a rectangular nozzle, having multiple measurement locations are beneficial for the analysis of complex samples such as tribometry test articles possessing fluid lubricant degradation products that are 3-dimensionally heterogeneous.

To further explain the stagnation point at the center of nozzle 220, there is a jet impinging orthogonal to substrate 125 comprised of thin fluid film 126 with a stagnation point at center of nozzle 220. To break it down in more detail, nozzle 220, lens 215, fiber optic probe 275 are in coaxial alignment and assembled into NOM 200. This alignment results in a common vertical axis that is used to orientate NOM 200 normal to the plane of substrate 125, and therefore, thin film fluid 126. Jet 115 emitted from nozzle 220 is then also normal to both substrate 125 and thin film fluid 126. When the jet impinges onto thin film fluid 126, the jet creates a stagnation point at the jet center, which is aligned with nozzle 220, lens 215, and fiber optic probe 275.

In short, fiber optic probe 275 is coaxially aligned or centered with the gas jet, which is impinging onto a thin fluid film coating the surface of substrate 125. By way of this alignment, a measurement can be made in reflectance with the fiber optic probe at the stagnation point. For instance, during measurement, the beam 285 may bounce off, or reflect back from, substrate 125 and into the sensing part of fiber optic probe 275.

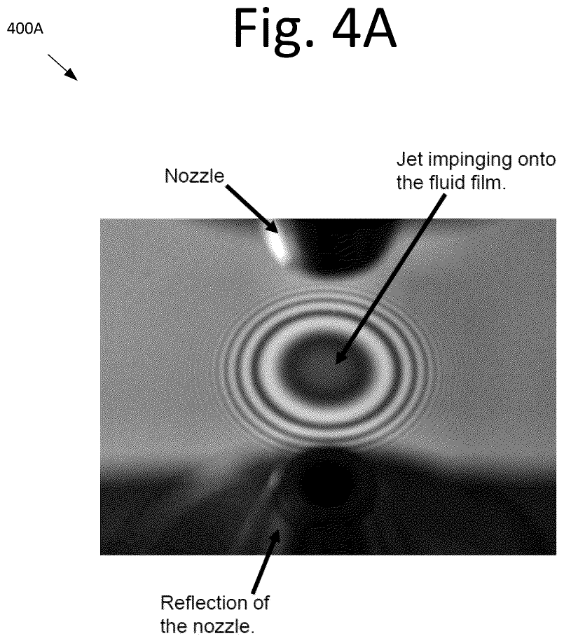

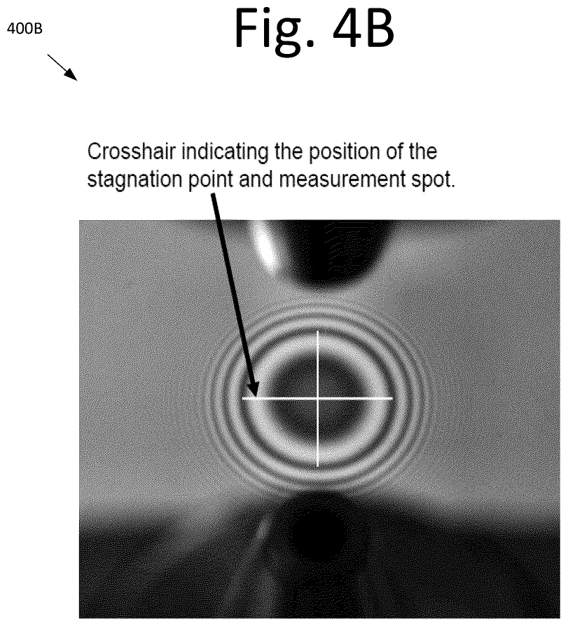

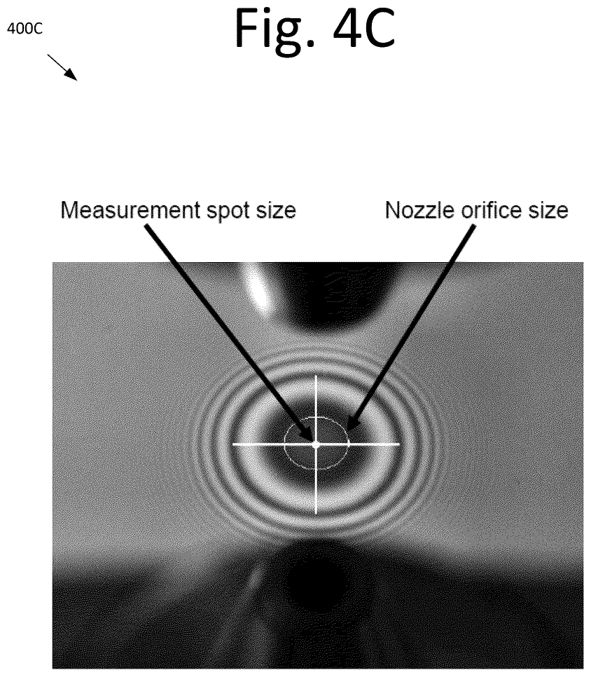

Although not shown in FIGS. 2A and 2B, some embodiments may include a camera 290. See, for example, FIG. 2C-E, which is a diagram illustrating other views of NOM 200, according to an embodiment of the present invention. In some embodiments, camera 290 is positioned near nozzle 220 of NOM 200. Camera 290 may be mounted to the manifold body of NOM 200 or to the same z-axis stage that NOM 200 is mounted to. In both embodiments, camera 290 and NOM 200 are moved together relative to substrate 125. The camera 290 can be of the general type with a fixed magnification operating in the visible spectrum like in FIG. 4. There may be a second camera, in some embodiments, for more advanced type of imaging such as those capable of thermal, hyperspectral and holographic imaging. NOM 200 may include multiple cameras with different functionality. In those embodiments, each camera includes lenses, filters and other elements (e.g., polarizers, beam splitters, mirrors, Peltier devices, filter wheels, positioners, light sources etc.) required to achieve the desired functionality (e.g., fluorescence detection).

As shown in FIG. 2B or 2E, it should be appreciated that the distance between the nozzle 220 of NOM 200 and substrate 125, termed the standoff distance (dₛ), is crucial to accurate film thickness and viscosity measurements. For this reason, camera 290 and PSD 295 may be used to align and adjust in the x-position, y-position and z-position nozzle 220, the jet impinging on the surface of substrate 125, and the fiber optic probe 275. Additionally, to ensure that the standoff distance (dₛ) between nozzle 220 and substrate 125 is optimum, a PSD 295 may be used. This is important with respect to calibration of the jet's stagnation flow strength (G), hydrodynamic constant (a) and viscosity measurement. It is also important to ensure that the focal point between the reference sample and substrate 125 is the same. Let's say, for example, there is a silicon wafer that is 500 microns thick, and it is used to collect (acquire) the background spectrum and is placed under nozzle 220. Then, let's say a 200 microns thick silicon wafer coated with a fluid film 126 is to be analyzed after background collection with the 500 micron thick silicon wafer. This difference in substrate 125 thickness changes the standoff distance (dₛ) and the focus of the fiber optic beam 285 reflecting off substrate 125. Together this may have an impact on the thickness measurement of thin fluid film 126 and repeatability of jet calibration values (G and a) causing a substantial error in viscosity measurement.

It should be noted that having poor control of standoff distance dₛ may result in two effects, at the very least. First, the variability in standoff distance dₛ affects stagnation flow strength G and hydrodynamic constant a that are used in generating the viscosity calibration curve. Higher repeatability in standoff distance dₛ improves repeatability in stagnation flow strength G and hydrodynamic constant a. Second, the variability in standoff distance dₛ also affects the quality/accuracy of the spectrum used to calculate the thickness of thin fluid film 126. This relates to the example where there is a 500 um and 200 um wafer thicknesses. What happens in this situation, the spectrum for the 200 um wafer is skewed (non-technical) because measurement is performed at a different focal plane than the 500 um reference. For thick films possessing interference fringes (ca. >200 nm with a UV-Vis spectrometer), the difference may be compensated during spectrum fitting/analysis. Stated differently, this type of compensation depends on if the film thickness spectrum analysis software has the ability. For thinner films, this focal plane offset becomes harder to compensate for and reduces measurement accuracy.

In short, camera 290 allows for alignment, that is, allows the fiber optic beam to be aligned with the stagnation point of the impinging jet. In some embodiments, camera 290 is configured to perform general imaging and perform measurement alignment as discussed above. In certain embodiments, camera 290 may ensure the standoff distance (dₛ) is the same for all samples, PSD 295 and camera 290 are both used to make sure that standoff distance (dₛ) is repeatable. In a CTFV instrument, the NOM may mount to a vertical, z-axis stage, which typically has a position encoder.

In certain embodiments, and as shown in FIG. 2B, the manifold body also includes holes (bores) and ports to control the temperature of the NOM and therefore the gas emitted from nozzle 220 that impinges onto the substrate comprised of the thin fluid film 126. In some further embodiments, a temperature control element (not shown) may control the temperature of the manifold, the nozzle, the fluid jet, or any combination thereof. To do this, fluid from an external heater or chiller can be passed through channels in the NOM manifold body as shown in FIG. 2B, or devices such as cartridge heaters and or Peltier coolers can be integrated into the NOM.

Also shown in FIG. 2C-E is a diffuser 299. In some embodiments, diffuser 299 is configured to provide a white background to which substrate 125 is superimposed thereon. In some further embodiments, diffuser 299 may include a diffuse light source such a light emitting diode (LED) or red, green, blue (RGB) panel. Another way to say the same thing is, the diffuser is superimposed onto substrate 125. Certain embodiments may use a diffuse light source, such as a small LED panel, that replaces the diffuser but also provides the same function (i.e., improve lighting, image quality and contrast of the sample being analyzed and of the stagnation zone during measurements). An RGB panel with color control in other embodiments may be used to track interference fringes outside the measurement location and should allow reconstructing 3D thickness maps from the images.

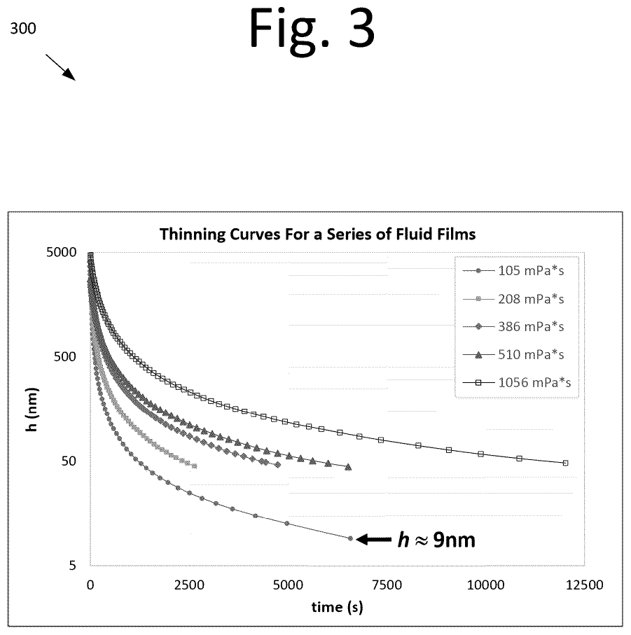

FIG. 3 is a graph 300 illustrating CTFV curves using a linear NOM for a homologous series of fluids, according to an embodiment of the present invention. In graph 300, the fluid film thickness is measured at the stagnation point, i.e., the location where the jet meets the surface of the fluid film, with respect to a function of time. The evolution curves h (t) in graph 300 are measured, and using theory, the fluid's viscosity is calculated by fitting h (t) data from the evolution curves. With h (t) data, various properties can be calculated, i.e., fluid viscosity, jet and solid-liquid interfacial.

FIG. 4A-C are images 400A-C acquired with camera illustrating the stagnation point between the jet and the thin film fluid, according to an embodiment of the present invention. In image 400A, the top portion of image 400A shows a nozzle while the bottom portion of image 400A shows the reflectance of the nozzle off the substrate. The jet in image 400A is impinging normal on the surface of fluid film, and at the center of the surface of the fluid film, the measurement is made.

In FIG. 4B, image 400B is with a crosshair overlay indicating the position of the stagnation point and measurement spot. More specifically, the crosshair indicates the position of the stagnation point and measure spot. In FIG. 4C, image 400 has an overlay indicating the size of measurement spot and nozzle orifice. The measurement spot size in this image 400C is at the center (i.e., the smallest circle) and nozzle orifice size is the larger circle closest to the center.

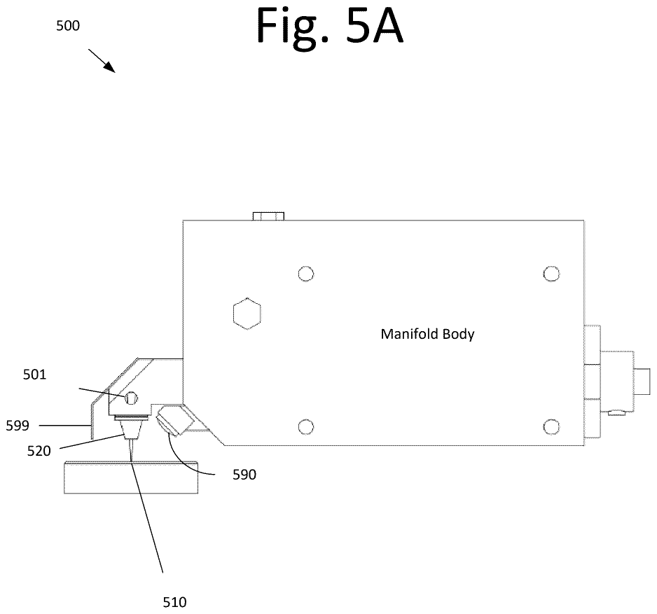

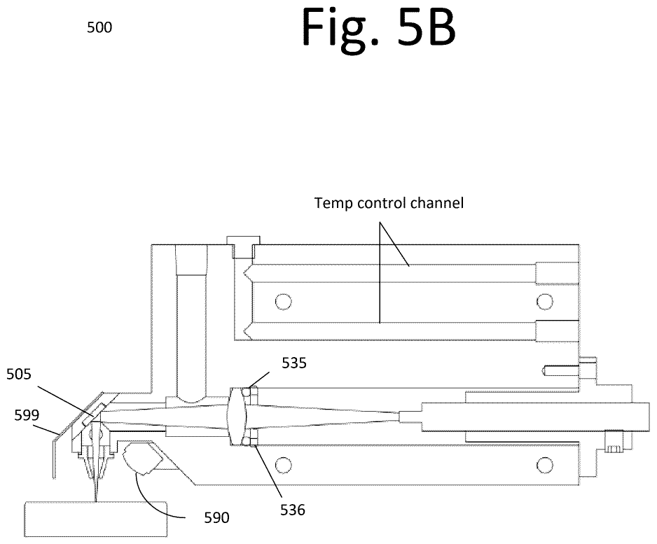

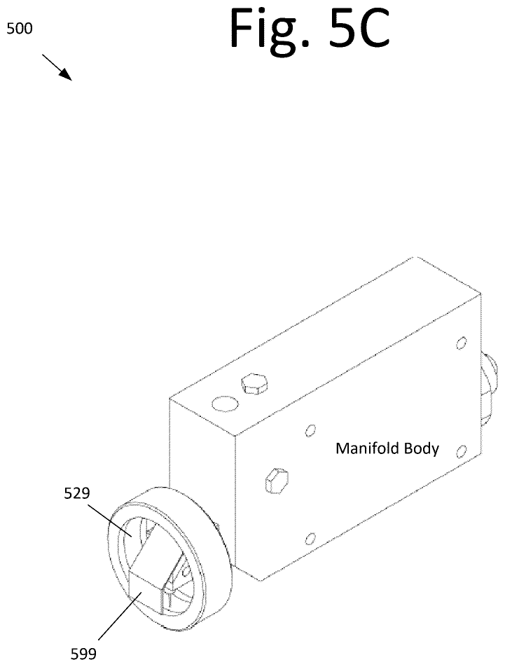

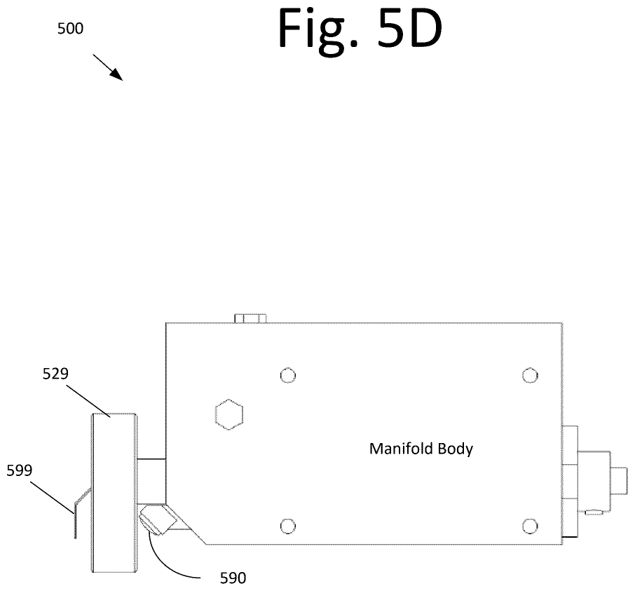

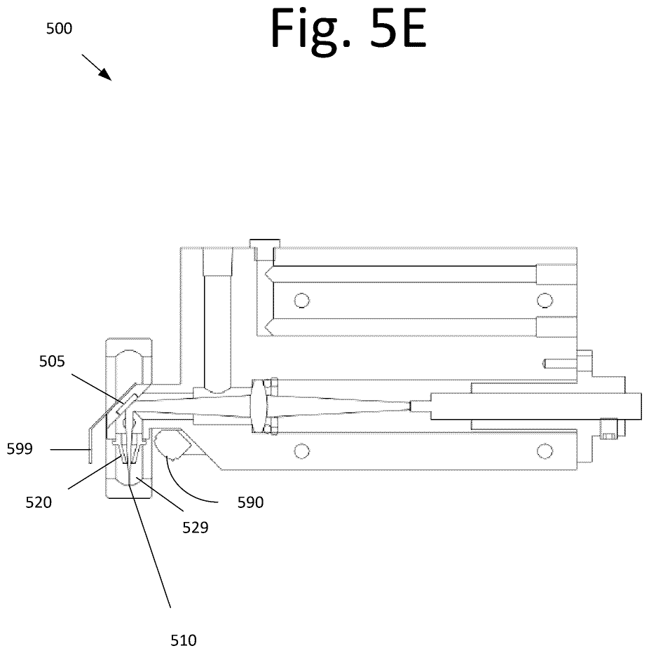

FIGS. 5A-E are diagrams illustrating an angled NOM 500, according to an embodiment of the present invention. In some embodiments, angled NOM 500 allows conducting measurements on articles with confined geometries such as engine cylinders and bearing outer raceways. Angled NOM 500 includes similar components to NOM 200. However, in this embodiment, angled NOM 500 uses an indirect optical path, and therefore, incorporates at least one mirror 505 to reflect the fiber optic beam, initially parallel with the surface, through nozzle 520 orifice that is arranged normal to the surface. This is more clearly seen in FIG. 5B. Similar to NOM 200, this embodiment enables coaxial alignment of the impinging gas jet with the measurement location and is therefore suitable to construct a CTFV instrument. It should be noted that measurement spot 510 is coaxial with a normal impinging gas jet emitted from nozzle 520 that shears a thin fluid film coating confined hardware geometries like a bearing outer raceway 529 in FIG. 5C-E.

It should be noted that the difference between FIGS. 5A-B and 5C-E is that the sample is flat in FIG. 5B and the sample is beveled due to the bearing outer raceway 529. See, for example, FIG. 5C-E, in which the nozzle of NOM 500 fits into and inspects a bearing outer raceway 529, a confined geometry.

Also shown in FIG. 5A are ports 501 for integrating temperature sensors and pressure sensors (not shown) into the manifold body and near the nozzle 520. There is a diffuser 599 configured to perform in the same manner as the diffuser 299 in FIGS. 2A-F. Similarly, there is a camera 590, which performs the same functions as camera 290 of FIGS. 2A-F.

Similar to the configuration in FIGS. 2A-F, NOM 500 of FIGS. 5A-E also includes a plurality of gaskets 535 and fasteners 536 that are configured to perform a similar function as gaskets 235 and fasteners 236.

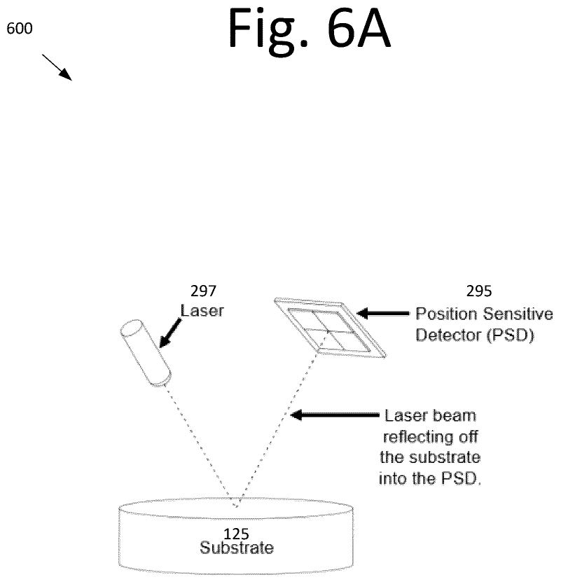

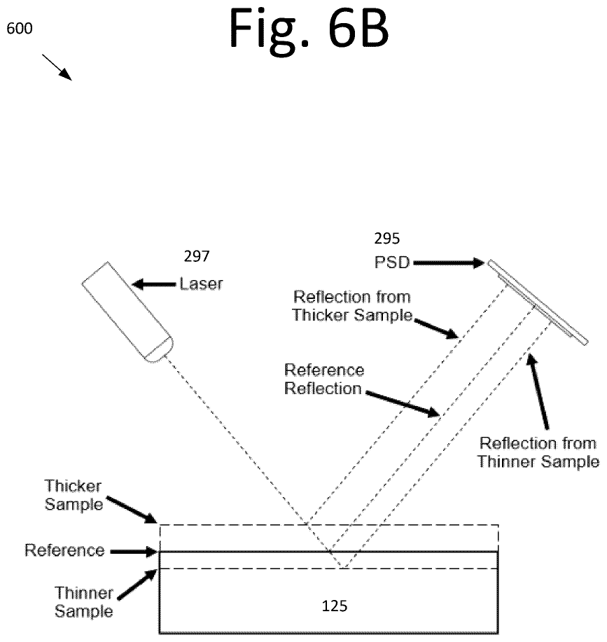

FIGS. 6A and 6B are diagrams illustrating a configuration 600 for triangulating with a PSD 295, according to an embodiment of the present invention. In this embodiment, laser 297 transmits a laser beam towards substrate 125, in which the laser beam reflects off substrate 125 into PSD 295. Substrate 125 and sample 120 may be one in the same depending on the embodiment. It should be noted that, depending on the thickness of sample 125, the position of reflection into PSD 295 may change. See, for example, FIG. 6B. More specifically, PSD 295 measures a high laser position for a substrate thicker than the reference substrate. This reading instructs the user to move the NOM or substrate vertically until the PSD reading matches the value recorded during background measurement with the reference sample. For instance, in FIG. 6B, PSD 295 may record “0” during background measurements with the reference. Now, when the thicker sample is measured, PSD 295 records a high value. The user may move the NOM or sample vertically until PSD 295 sees “0” to match the reference value. Once matched to “0”, the user proceeds to make viscosity measurements.

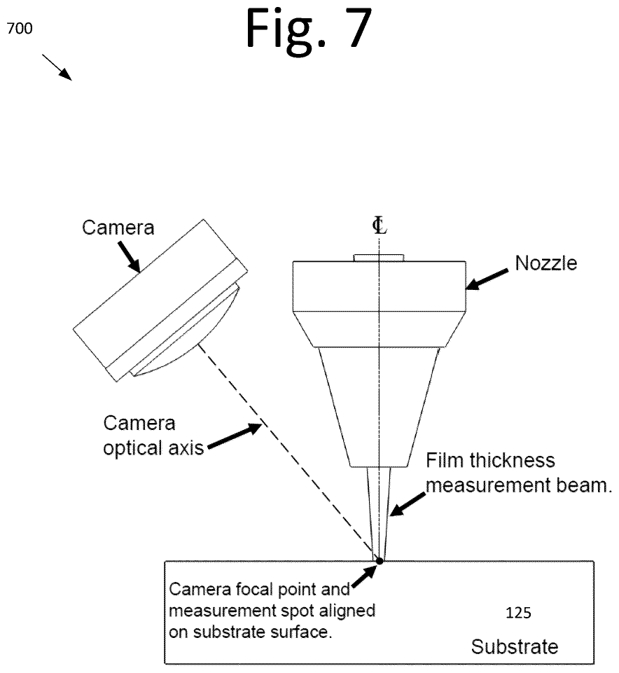

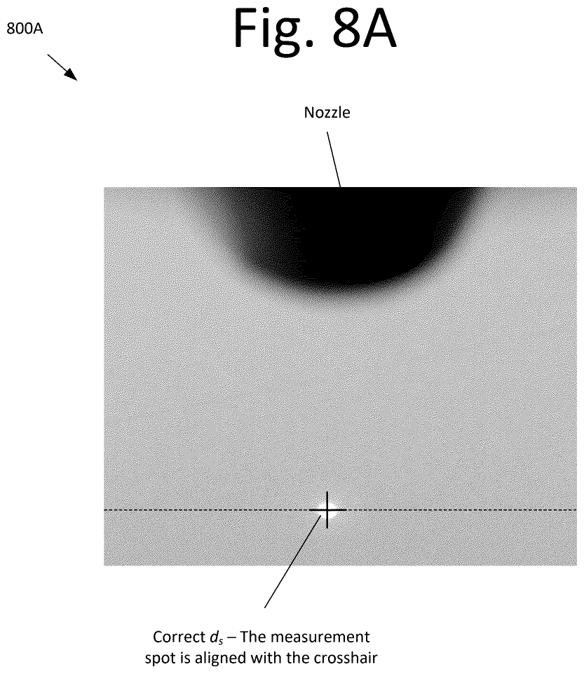

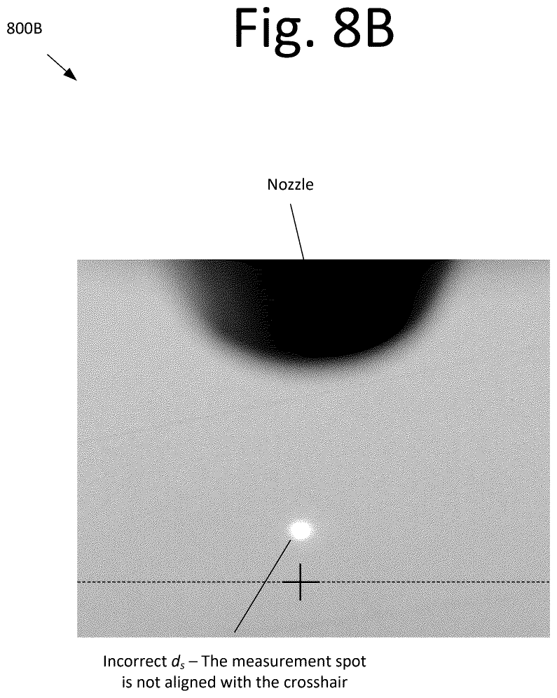

FIG. 7 is a diagram illustrating a camera triangulation schematic 700, according to an embodiment of the present invention. In this embodiment, at the correct standoff distance dₛ, the camera focal point and measurement spot are aligned on the surface of substrate 125. See, for example, FIGS. 8A and 8B, which show images 800A and 800B illustrating use of camera triangulation, according to an embodiment of the present invention. In image 800B, the correct standoff distance is shown, i.e., at the correct standoff distance dₛ, the camera focal point and the measurement spot are aligned on the substrate surface. In image 800B, the incorrect standoff distance dₛ is shown, i.e., the measurement spot is not aligned with the crosshair. In this case, when standoff distance dₛ is incorrect, the NOM or sample is moved vertically to align the measurement spot with the crosshair.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A nozzle optical manifold (NOM), comprising:
a tube configured to transmit a measurement beam and a fluid jet onto a surface of a substrate, wherein the surface of the substrate comprises a thin fluid film; and
a fiber optic probe placed inside of the tube and the measurement beam from the fiber optic probe is optically aligned with a jet impingement point, wherein the impingement point is a location at which the measurement beam impinges onto the thin fluid film, wherein
the fiber optic probe is configured to measure thickness and viscosity of the thin film fluid.

2. The NOM of claim 1, further comprising:
a nozzle attached to the tube, and is configured to impinge a fluid jet onto thin film fluid, allowing for the thickness and viscosity of the thin film fluid to be measured.

3. The NOM of claim 1, further comprising:
a camera configured to mount to a manifold of the NOM or to a z-axis stage mounted to the manifold of the NOM; and
a position sensitive detector, wherein
the camera and the position sensitive detector are configured to align and adjust a nozzle in an x-position, y-position and z-position, the fluid jet impinging on the surface of the substrate, one or more lenses, and the fiber optic probe, including the measurement beam.

4. The NOM of claim 3, wherein the position sensitive detector and the camera are configured to measure a standoff distance, the standoff distance being a distance between the nozzle and the substrate or the surface of the substrate.

5. The NOM of claim 3, wherein the positioner is a z-axis stage configured to mount and hold the NOM above the substrate, thereby preserving a standoff distance.

6. The NOM of claim 5, wherein the z-axis stage is configured to move the NOM up and down to a correct standoff height or a correct standoff distance.

7. The NOM of claim 3, further comprising:
a laser configured to transmit a laser beam towards a substrate, causing the laser beam to reflect off of the substrate and onto the position sensitive detector.

8. The NOM of claim 3, wherein the position sensitive detector is configured to measure a high laser position or a low laser position for a substrate thicker or thinner than a reference sample, and provide a reading to a user for moving the NOM.

9. The NOM of claim 6, wherein the camera is configured to measure position data between the surface of the substrate and the NOM, and further configured to transmit the position data to the z-axis positioner in order to move the NOM to the correct standoff height or the correct standoff distance.

10. The NOM of claim 1, further comprising:
a focusing lens for the measurement beam fixed in position or configured to facilitate x-y-z translation to align the measurement beam with the nozzle and fluid jet.

11. The NOM of claim 1, further comprising:
a diffuser configured to provide a white background to which the substrate is superimposed thereon.

12. A nozzle optical manifold (NOM), comprising:
a tube configured to transmit a measurement beam and fluid jet onto a surface of a substrate through a nozzle, wherein the surface of the substrate comprises a thin fluid film; and
a fiber optic probe placed inside of the tube and the measurement beam from the fiber optic probe is optically aligned with the jet impingement point, wherein the impingement point is a location at which the measurement beam impinges onto the thin fluid film, wherein
the nozzle attached to the tube is configured to impinge the fluid jet onto thin film fluid, allowing for thickness and viscosity of the thin film fluid to be measured, wherein
the fiber optic probe is configured to measure the thickness and viscosity of the thin film fluid.

13. The NOM of claim 12, further comprising:
a camera configured to mount to a manifold of the NOM or to a z-axis of a stage mounted to the manifold of the NOM; and
a position sensitive detector, wherein
the camera and the position sensitive detector are configured to align and adjust a nozzle in an x-position, y-position and z-position, the fluid jet impinging on the surface of the substrate, one or more lenses, and the fiber optic probe, including the measurement beam.

14. The NOM of claim 13, wherein the position sensitive detector and the camera are configured to measure a standoff distance, the standoff distance being a distance between the nozzle and the substrate or the surface of the substrate.

15. The NOM of claim 13, wherein the positioner is a z-axis stage configured to mount and hold the NOM above the substrate, thereby preserving a standoff distance.

16. The NOM of claim 15, wherein the z-axis stage is configured to move the NOM up and down to a correct standoff height or a correct standoff distance.

17. The NOM of claim 13, further comprising:
a laser configured to transmit a laser beam towards a substrate, causing the laser beam to reflect off of the substrate and onto the position sensitive detector.

18. The NOM of claim 13, wherein the position sensitive detector is configured to measure a high laser position or a low laser position for a substrate thicker or thinner than a reference sample, and provide a reading to a user for moving the NOM.

19. The NOM of claim 16, wherein the camera is configured to measure position data between the surface of the substrate and the NOM, and further configured to transmit the position data to the z-axis positioner in order to move the NOM to the correct standoff height or the correct standoff distance.

20. The NOM of claim 12, further comprising:
a focusing lens for the measurement beam fixed in position or configured to facilitate x-y-z translation to align the measurement beam with the nozzle and fluid jet.

21. The NOM of claim 12, further comprising:
a diffuser configured to provide a white background to which the substrate is superimposed thereon.

22. The NOM of claim 12, further comprising:
a controller integrated into or part of the manifold body, and configured to control flow rate and/or pressure of the fluid jet.

23. The NOM of claim 12, further comprising:
a plurality of sensors configured to measure one or more properties of the fluid jet, one or more properties of the NOM, one or more properties of a controlled or ambient environment, or any combination thereof.

24. The NOM of claim 12, further comprising:
a temperature control element configured to control temperature of the manifold, the nozzle, the fluid jet, or any combination thereof.

25. The NOM of claim 13, further comprising:
a plurality of cameras configured to capture imaging to show one or more properties of the fluid jet, thin fluid film, and the substrate.
